(19) United States
(12) Patent Application Publication
(10) Pub. No.: US 2010/0033027 A1
(43) Pub. Date: Feb. 11, 2010

(54) Automatic Pole

(76) Inventors: Yeping Fan, Shanghai (CN); Jian Li, Shanghai (CN); Changchun Zhu, Shanghai (CN)

Correspondence Address: CHRISTIE, PARKER & HALE, LLP, PO BOX 7068, PASADENA, CA, 91109-7068, US

(21) Appl. No.: 12/223,684

(22) PCT Filed: Aug. 5, 2006
(86) PCT No.: PCT/CN2006/001595

§ 371 Date: Aug. 6, 2008

(30) Foreign Application Priority Data
Jun. 30, 2006 (CN) 200610028427.8

(51) Int. Cl. H02H 11/00

(52) U.S. Cl. 307/127; 361/246

(57) ABSTRACT

An automatic pole includes a mechanical push device and a circuit board device electric-connected with each other. The mechanical push device includes a magnetic inductance device, a contact device, and a housing. The circuit board device comprises a control circuit and an internal cell. The control circuit includes a first optoelectronic coupler and a second optoelectronic coupler electric-connected with each other, and a first transistor which base is connected to the first optoelectronic coupler and a second transistor which base is connected to the second optoelectronic coupler.

### TECHNICAL FIELD

The present invention relates to an automatic pole applicable to the emergency power supply for vehicle, which belongs to the technical field of emergency power supply for vehicle.

### BACKGROUND ART

In general, when an emergency power supply for vehicle is used to charge, it is necessary to distinguish manually the positive and negative poles connected, wherein a red mark indicates that it should be connected to the positive pole and a black mark indicates that it should be connected to the negative pole. However, when the environment is dark or the positive and negative marks on a charger are indistinct, it is liable to connect the positive and negative poles in an inverse polarity, and once to do so, a tremendous current will be output, which results in short circuit and damaging the power supply and the relevant equipments.

### SUMMARY

In order to protect the power supply and the relevant electric equipments, the present invention provides an automatic pole which can automatically correct the wrong connection of the positive and negative poles and avoid the short circuit resulting from the inverse polarity of the poles connected and the corresponding endangerments occurring probably by means of a simple circuit and some ordinary components.

In order to achieve the above-mentioned purpose, the present invention provides an automatic pole comprising a mechanical driving device and a circuit board device which are connected in a circuit.

Said mechanical driving device comprises an electromagnetic solenoid device and a contact devise.

Said mechanical driving device further comprises a housing in which said electromagnetic solenoid device and said contact device are housed.

Said electromagnetic solenoid device comprises a first electromagnetic solenoid, a second electromagnetic solenoid, a first driving core and a second driving core passing through the first electromagnetic solenoid and the second electromagnetic solenoid respectively, and a connecting shaft connecting the first driving core and the second driving core.

Said first electromagnetic solenoid comprises a forward coil; said second electromagnetic solenoid comprises a backward coil.

Said contact device comprises a first movable contact and a second movable contact which are provided vertically on said connecting shaft and parallel to each other, a first rest contact and a second rest contact which are provided on the housing on one side of said movable contacts, and a third rest contact and a fourth rest contact which are provided on the housing on the other side of said movable contacts.

Said first rest contact is positioned on the outside of the first movable contact and the second movable contact; said second rest contact is positioned on the inside of the first movable contact and the second movable contact; said third rest contact is positioned on the outside of the first movable contact; and said fourth rest contact is positioned on the outside of the second movable contact.

Said circuit board device comprises a controlling circuit and an internal cell.

Said internal cell provides the controlling circuit with a positive voltage and a negative voltage, the positive pole of the internal cell is electro-connected to the first electromagnetic solenoid and the first rest contact in said mechanical driving device to electrify positively these two; and the negative pole of the internal cell is electro-connected to the second electromagnetic solenoid and the second rest contact in said mechanical driving device to electrify negatively these two.

Said controlling circuit comprises a first photoelectric coupler and a second photoelectric coupler which are connected in the circuit, and a first transistor the base of which is connected to said first photoelectric coupler and a second transistor the base of which is connected to said second photoelectric coupler.

The collector of said first transistor outputs a signal to the first electromagnetic solenoid in said mechanical driving device; the collector of said second transistor outputs a signal to the second electromagnetic solenoid in said mechanical driving device.

Said controlling circuit further comprises a number of resistors and diodes.

The positive and negative voltage inputting terminals of said controlling circuit are electro-connected to the third rest contact and the fourth rest contact in said mechanical driving device respectively.

Said automatic pole further comprises two power supply clamps, which are electro-connected to the positive and negative voltage inputting terminals of said controlling circuit respectively.

When the automatic pole of the present invention is used to charge an external power supply, the power supply clamps are connected to the positive and negative poles of the external power supply. If the first power supply clamp is connected to the positive pole of the external power supply and the second power supply clamp is connected to the negative pole thereof, the first photoelectric coupler operates, which makes the first transistor ON and the collector thereof output a lower level signal to the first electromagnetic solenoid in the mechanical driving device; then the first electromagnetic solenoid is electrified and actuated so as to drive the mechanical driving device to move mechanically, which makes the first movable contact come into contact with the first and the third rest contacts respectively to electrify positively the third rest contact, and the second movable contact with the second and the fourth rest contacts respectively to electrify negatively the fourth rest contact, as a result, the first power supply clamp is connected to the positive pole of the internal cell and the second power supply clamp is connected to the negative pole thereof.

On the other hand, when the automatic pole of the present invention is used to charge an external power supply, if the first power supply clamp is connected to the negative pole of the external power supply and the second power supply clamp is connected to the positive pole thereof, the second photoelectric coupler operates, which makes the second transistor ON and the collector thereof output a lower level signal to the second electromagnetic solenoid in the mechanical driving device; then the second electromagnetic solenoid is electrified and actuated so as to drive the mechanical driving device to move mechanically, which makes the first movable contact come into contact with the second and the third rest contacts respectively to electrify negatively the third rest contact, and the second movable contact with the first and the fourth rest contacts respectively to electrify positively the fourth rest contact, as a result, the first power supply clamp is connected to the negative pole of the internal cell and the second power supply clamp is connected to the positive pole thereof.

When neither the first nor the second power supply clamp has a signal, none of the first and the second photoelectric couplers operates, which makes both the first and the second transistors output the high level; then none of the first and the second electromagnetic solenoids is actuated, and the mechanical driving device makes the first and the second power supply clamps in the disengaging state by means of the internal elastic force, as a result, the automatic pole as a whole does not operate.

The automatic pole of the present invention can automatically correct the wrong connection of the positive and negative poles and avoid the short circuit resulting from the inverse polarity of the poles connected and the corresponding endangerment occurring probably so as to achieve the purpose for protecting the power supply and the relevant electric equipments. The automatic pole has a convenient using performance and a strong operability, and can adjust automatically the polarity of the terminals connected at all time during an emergency power supply operates, therefore, the emergency power supply and the relevant electric equipments connected therewith can be protected powerfully.

### BRIEF DESCRIPTION OF ACCOMPANYING DRAWING

The present invention will be described with reference to the accompanying drawing, in which

FIG. 1 is a schematic structural view of the automatic pole of the present invention;

FIG. 2 is a circuit principle view of the circuit board device of the automatic pole of the present invention;

FIG. 3 is an operational principle view of the automatic pole of the present invention in the normal connection; and

FIG. 4 is an operational principle view of the automatic pole of the present invention in the inverse connection.

### DETAILED DESCRIPTION OF PREFERRED EMBODIMENT

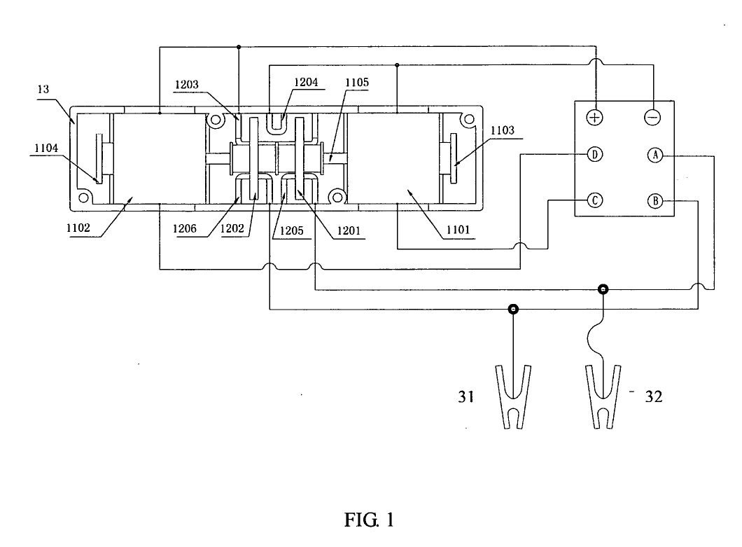

The following will explain the preferred embodiment of the present invention with reference to the FIG. 1 to FIG. 4.

As shown in FIG. 1, the present invention provides an automatic pole comprising a mechanical driving device and a circuit board device which are connected in a circuit.

Said mechanical driving device comprises an electromagnetic solenoid device and a contact devise.

Said mechanical driving device further comprises housing 13 in which said electromagnetic solenoid device and said contact device are housed.

Said electromagnetic solenoid device comprises first electromagnetic solenoid 1101, second electromagnetic solenoid 1102, first driving core 1103 and second driving core 1104 passing through first electromagnetic solenoid 1101 and second electromagnetic solenoid 1102 respectively, and connecting shaft 1105 connecting first driving core 1103 and second driving core 1104.

Said first electromagnetic solenoid 1101 comprises a forward coil; said second electromagnetic solenoid 1102 comprises a backward coil.

Said contact device comprises first movable contact 1201 and second movable contact 1202 which are provided vertically on said connecting shaft 1105 and parallel to each other, first rest contact 1203 and second rest contact 1204 which are provided on housing 13 on one side of said movable contacts, and third rest contact 1205 and fourth rest contact 1206 which are provided on housing 13 on the other side of said movable contacts.

Said first rest contact 1203 is positioned on the outside of first movable contact 1201 and second movable contact 1202; said second rest contact 1204 is positioned on the inside of first movable contact 1201 and second movable contact 1202; said third rest contact 1205 is positioned on the outside of first movable contact 1201; and said fourth rest contact 1206 is positioned on the outside of second movable contact 1202.

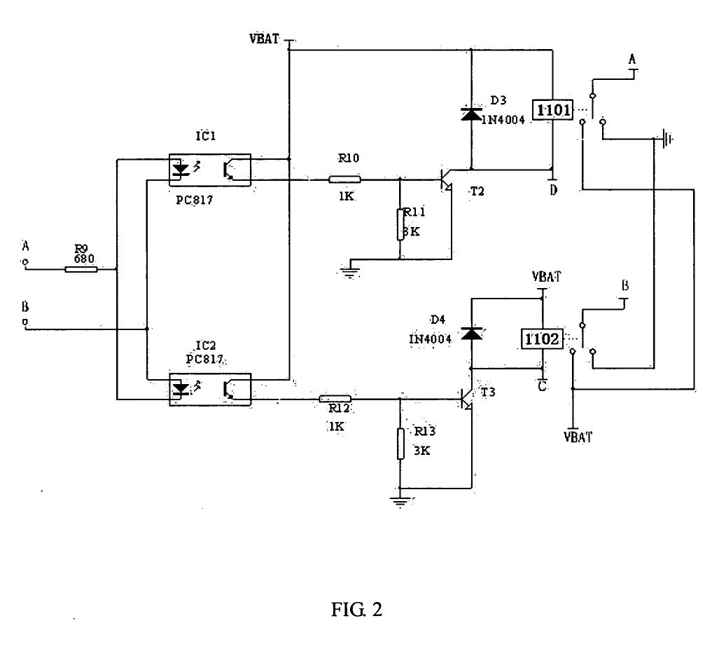

As shown in FIG. 2, said circuit board device comprises a controlling circuit and internal cell 22.

Said internal cell 22 provides the controlling circuit with a positive voltage and a negative voltage, the positive pole of internal cell 22 is electro-connected to first electromagnetic solenoid 1101 and first rest contact 1203 in said mechanical driving device to electrify positively these two; and the negative pole of internal cell 22 is electro-connected to second electromagnetic solenoid 1102 and second rest contact 1204 in said mechanical driving device to electrify negatively these two.

Said controlling circuit comprises first photoelectric coupler IC1 and second photoelectric coupler IC2 which are connected in the circuit, and first transistor T2 the base of which is connected to said first photoelectric coupler IC1 and second transistor T3 the base of which is connected to said second photoelectric coupler IC2.

In the embodiment, the model of first photoelectric coupler IC1 and second photoelectric coupler IC2 is PC817, and the model of first transistor T2 and second transistor T3 is IN4004.

The collector of said first transistor T2 is electro-connected to first electromagnetic solenoid 1101 in said mechanical driving device and outputs a signal thereto; the collector of said second transistor T3 is electro-connected to second electromagnetic solenoid 1102 in said mechanical driving device and outputs a signal thereto.

Said controlling circuit further comprises a number of resistors R9, R10, R11, R12, R13 and diodes D3, D4.

The positive and negative voltage inputting terminals A, B of said controlling circuit are electro-connected to third rest contact 1205 and fourth rest contact 1206 in said mechanical driving device respectively.

Said automatic pole further comprises two power supply clamps 31, 32, which are electro-connected to positive and negative voltage inputting terminals A, B of said controlling circuit respectively.

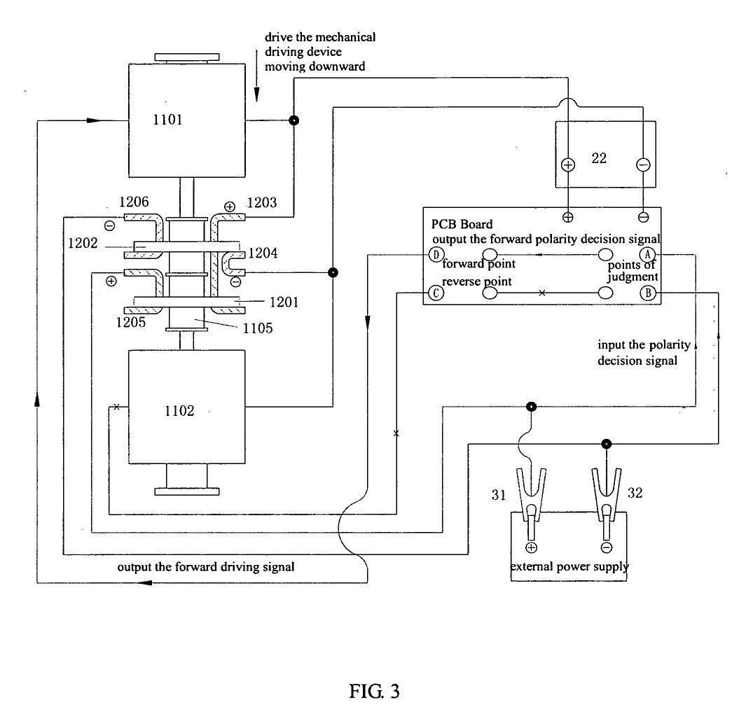

As shown in FIG. 3, when the automatic pole of the present invention is used to charge an external power supply, power supply clamps 31, 32 are connected to the positive and negative poles of the external power supply. If first power supply clamp 31 is connected to the positive pole of the external power supply and second power supply clamp 32 is connected to the negative pole thereof, first photoelectric coupler IC1 operates, which makes first transistor T2 ON and collector D thereof output a lower level signal to first electromagnetic solenoid 1101 in the mechanical driving device; then first electromagnetic solenoid 1101 is electrified and actuated so as to drive the mechanical driving device to move mechanically, which makes first movable contact 1201 come into contact with first rest contact 1203 and third rest contact 1205 respectively to electrify positively third rest contact 1205, and second movable contact 1202 with second rest contact 1204 and fourth rest contact 1206 respectively to electrify negatively fourth rest contact 1206, as a result, first power supply clamp 31 is connected to the positive pole of internal cell 22 and second power supply clamp 32 is connected to the negative pole thereof.

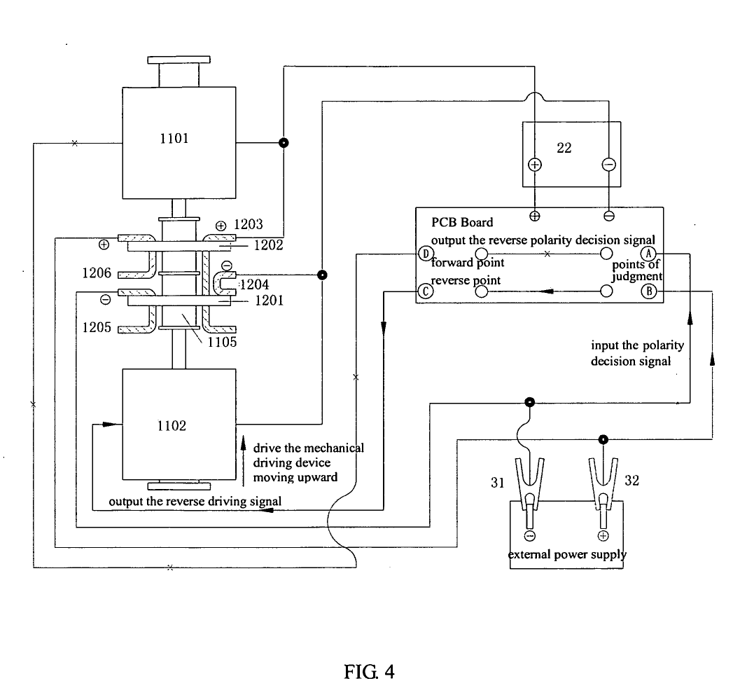

On the other hand, as shown in FIG. 4, when the automatic pole of the present invention is used to charge an external power supply, if first power supply clamp 31 is connected to the negative pole of the external power supply and second power supply clamp 32 is connected to the positive pole thereof, second photoelectric coupler IC2 operates, which makes second transistor T3 ON and the collector thereof output a lower level signal to second electromagnetic solenoid 1102 in the mechanical driving device; then second electromagnetic solenoid 1102 is electrified and actuated so as to drive the mechanical driving device to move mechanically, which makes first movable contact 1201 come into contact with second rest contact 1204 and third rest contact 1205 respectively to electrify negatively third rest contact 1205, and second movable contact 1202 with first rest contact 1203 and fourth rest contact 1206 respectively to electrify positively fourth rest contact 1206, as a result, first power supply clamp 31 is connected to the negative pole of internal cell 22 and second power supply clamp 32 is connected to the positive pole thereof.

When neither first power supply clamp 31 nor second power supply clamp 32 has a signal, none of first photoelectric coupler IC1 and second photoelectric coupler IC2 operates, which makes both first transistor T2 and second transistor T3 output the high level; then none of first electromagnetic solenoid 1101 and second electromagnetic solenoid 1102 is actuated, and the mechanical driving device makes first power supply clamp 31 and second power supply clamp 32 in the disengaging state by means of the internal elastic force, as a result, the automatic pole as a whole does not operate.

The automatic pole of the present invention can automatically correct the wrong connection of the positive and negative poles and avoid the short circuit resulting from the inverse polarity of the poles connected and the corresponding endangerment occurring probably so as to achieve the purpose for protecting the power supply and the relevant electric equipments. The automatic pole has a convenient using performance and a strong operability, and can adjust automatically the polarity of the terminals connected at all time during an emergency power supply operates, therefore, the emergency power supply and the relevant electric equipments connected therewith can be protected powerfully.

1. An automatic pole comprising a mechanical driving device and a circuit board device which are connected in a circuit;
said mechanical driving device comprises an electromagnetic solenoid device, a contact devise and a housing (13);
said electromagnetic solenoid device comprises a first electromagnetic solenoid (1101), a second electromagnetic solenoid (1102), a first driving core (1103) and a second driving core (1104) passing through the first electromagnetic solenoid (1101) and the second electromagnetic solenoid (1102) respectively, and a connecting shaft (1105) connecting the first driving core (1103) and the second driving core (1104);
said contact device comprises a first movable contact (1201) and a second movable contact (1202) which are provided vertically on said connecting shaft (1105) and parallel to each other, a first rest contact (1203) and a second rest contact (1204) which are provided on the housing (13) on one side of said movable contacts, and a third rest contact (1205) and a fourth rest contact (1206) which are provided on the housing (13) on the other side of said movable contacts;
said circuit board device comprises a controlling circuit and an internal cell (22);
said controlling circuit comprises a first photoelectric coupler (IC1) and a second photoelectric coupler (IC2) which are connected in the circuit, and a first transistor (T2) the base of which is connected to said first photoelectric coupler (IC1) and a second transistor (T3) the base of which is connected to said second photoelectric coupler (IC2);
the collector of said first transistor (T2) is electro-connected to the first electromagnetic solenoid (1101) in said mechanical driving device and outputs a signal thereto; the collector of said second transistor (T3) is electro-connected to the second electromagnetic solenoid (1102) in said mechanical driving device and outputs a signal thereto.

2. The automatic pole according to claim 1, wherein said first electromagnetic solenoid (1101) comprises a forward coil; said second electromagnetic solenoid (1102) comprises a backward coil.

3. The automatic pole according to claim 1, wherein said first rest contact (1203) is positioned on the outside of the first movable contact (1201) and the second movable contact (1202); said second rest contact (1204) is positioned on the inside of the first movable contact (1201) and the second movable contact (1202); said third rest contact (1205) is positioned on the outside of the first movable contact (1201); and said fourth rest contact (1206) is positioned on the outside of the second movable contact (1202).

4. The automatic pole according to claim 1, wherein said internal cell (22) provides the controlling circuit with a positive voltage and a negative voltage, the positive pole of the internal cell (22) is electro-connected to the first electromagnetic solenoid (1101) and the first rest contact (1203) in said mechanical driving device to electrify positively these two; and the negative pole of the internal cell (22) is electro-connected to the second electromagnetic solenoid (1102) and the second rest contact (1204) in said mechanical driving device to electrify negatively these two.

5. The automatic pole according to claim 1, wherein said controlling circuit further comprises a number of resistors (R9, R10, R11, R12, R13) and diodes (D3, D4).

6. The automatic pole according to claim 1, wherein the positive and negative voltage inputting terminals (A, B) of said controlling circuit are electro-connected to the third rest contact (1205) and the fourth rest contact (1206) in said mechanical driving device respectively.

7. The automatic pole according to claim 1, wherein said automatic pole further comprises a first power supply clamps (31) and a second power supply clamp (32), which are electro-connected to the positive and negative voltage inputting terminals (A, B) of said controlling circuit respectively.

8. An automatic pole comprising a mechanical driving device and a circuit board device which are connected in a circuit;
said mechanical driving device comprises an electromagnetic solenoid device, a contact devise and a housing (13);
said circuit board device comprises a controlling circuit and an internal cell (22).

9. The automatic pole according to claim 8, wherein said electromagnetic solenoid device comprises a first electromagnetic solenoid (1101), a second electromagnetic solenoid (1102), a first driving core (1103) and a second driving core (1104) passing through the first electromagnetic solenoid (1101) and the second electromagnetic solenoid (1102) respectively, and a connecting shaft (1105) connecting the first driving core (1103) and the second driving core (1104).

10. The automatic pole according to claim 8, wherein said contact device comprises a first movable contact (1201) and a second movable contact (1202) which are provided vertically on said connecting shaft (1105) and parallel to each other, a first rest contact (1203) and a second rest contact (1204) which are provided on the housing (13) on one side of said movable contacts, and a third rest contact (1205) and a fourth rest contact (1206) which are provided on the housing (13) on the other side of said movable contacts.

11. The automatic pole according to claim 8, wherein said controlling circuit comprises a first photoelectric coupler (IC1) and a second photoelectric coupler (IC2) which are connected in the circuit, and a first transistor (T2) the base of which is connected to said first photoelectric coupler (IC1) and a second transistor (T3) the base of which is connected to said second photoelectric coupler (IC2).

12. The automatic pole according to claim 9, wherein the collector of said first transistor (T2) is electro-connected to the first electromagnetic solenoid (1101) in said mechanical driving device and outputs a signal thereto; the collector of said second transistor (T3) is electro-connected to the second electromagnetic solenoid (1102) in said mechanical driving device and outputs a signal thereto.

13. The automatic pole according to claim 9, wherein said first electromagnetic solenoid (1101) comprises a forward coil; said second electromagnetic solenoid (1102) comprises a backward coil.

14. The automatic pole according to claim 10, wherein said first rest contact (1203) is positioned on the outside of the first movable contact (1201) and the second movable contact (1202); said second rest contact (1204) is positioned on the inside of the first movable contact (1201) and the second movable contact (1202); said third rest contact (1205) is positioned on the outside of the first movable contact (1201); and said fourth rest contact (1206) is positioned on the outside of the second movable contact (1202).

15. The automatic pole according to claim 9, wherein said internal cell (22) provides the controlling circuit with a positive voltage and a negative voltage, the positive pole of the internal cell (22) is electro-connected to the first electromagnetic solenoid (1101) and the first rest contact (1203) in said mechanical driving device to electrify positively these two; and the negative pole of the internal cell (22) is electro-connected to the second electromagnetic solenoid (1102) and the second rest contact (1204) in said mechanical driving device to electrify negatively these two.

16. The automatic pole according to claim 11, wherein said controlling circuit further comprises a number of resistors (R9, R10, R11, R12, R13) and diodes (D3, D4).

17. The automatic pole according to claim 10, wherein the positive and negative voltage inputting terminals (A, B) of said controlling circuit are electro-connected to the third rest contact (1205) and the fourth rest contact (1206) in said mechanical driving device respectively.

18. The automatic pole according to claim 17, wherein said automatic pole further comprises a first power supply clamps (31) and a second power supply clamp (32), which are electro-connected to the positive and negative voltage inputting terminals (A, B) of said controlling circuit respectively.
